(19) United States
(12) Patent Application Publication
(10) Pub. No.: US 2006/0245876 A1
(43) Pub. Date: Nov. 2, 2006

(54) Method and apparatus for transporting containers

(76) Inventors: William Hopkins, College Park, MD (US); Lillian A. Hopkins, Silver Spring, MD (US); Mary Ann Hopkins, College Park, MD (US)

Correspondence Address: BRUCE E. WEIR, 12 SPARROW VALLEY COURT, MONTGOMERY VILLAGE, MD, 20886-1265, US

(21) Appl. No.: 11/371,032

(22) Filed: Mar. 8, 2006

Related U.S. Application Data
(60) Provisional application No. 60/667,920, filed on Apr. 4, 2005.

(51) Int. Cl. B65F 3/26

(52) U.S. Cl. 414/482

(57) ABSTRACT

A hand-drawn cart for transporting one or more containers has raised sides and a rear ramp that may be locked in a vertical transporting position or unlocked and rotated into an unloading position. A recycling bin or other containers may be stored upon the cart, loaded with recyclables, then the cart may be rolled to a curbside collection location with the ramp locked. The ramp is unlocked and lowered at the collection location, the front end of the cart is lifted to slide a container down the ramp, the cart is drawn forward to withdraw the ramp from beneath the container, and the ramp is rotated back up to a locked position.

### CROSS-REFERENCE TO RELATED APPLICATION

This application claims priority from provisional patent application Ser. No. 60/667,920, filed Apr. 4, 2005 by the same inventors, now pending.

### BACKGROUND AND SUMMARY

Environmental issues are of utmost concern in today's society. With disturbing knowledge regarding the depletion of the ozone layer, oil spills in the ocean, and overflowing landfills, Americans are beginning to take action in protecting the Earth's fragile ecosystem. Fast food restaurants have all but halted the packaging of burgers and sandwiches in Styrofoam containers, the sale of aerosol deodorants and hairsprays are slowly declining in favor of more “eco-friendly” versions, and community recycling programs are springing up all over the country.

Recycling, in particular, is a major force in environmental care. In fact, Americans are so committed to recycling that according to the U.S. Environmental Protection Agency (EPA), recycling has increased 28% in the last ten years. With the motto “Reduce, Reuse, Recycle” heralding the way for environmental efficiency, consumers are beginning to appreciate the importance of reducing waste and reusing materials typically thrown away.

To encourage recycling within the community, many cities and towns offer curbside pickup of recyclable materials such as aluminum cans, glass bottles, and newspapers. In many areas recycling is required by law. Typically, household consumers use rectangular bins to separate recyclable goods, filling these bins to capacity and then placing them curbside for collection by the local recycling center. Most community recycling centers pick up recyclable goods on a weekly basis.

Unfortunately, a bin loaded with a week's worth of glass bottles or newspapers can be extremely heavy, making the task of transporting the bin to the curb quite challenging for many consumers. In particular, senior citizens, people with limited mobility, and children whose chore it is to carry out recycle bins often experience difficulty in hauling these cumbersome loaded containers. As anyone who has ever carried a loaded recycle bin would readily attest, doing one's part to protect the environment only to wind up with aching neck and shoulder muscles as a result of carrying a heavy recycle bin can be a frustrating experience.

The present invention provides consumers who participate in community recycling campaigns a simple and efficient means for transporting loaded recycle bins from their home to the curb for collection. A portable cart stores a recycling bin as the bin is loaded. The cart is drawn by hand to a collection location, a rear ramp attached to the cart is lowered to the ground, the front of the cart is lifted to slide the bin to the ground, the cart is drawn forward to withdraw the ramp from beneath the bin, then the ramp is raised and locked into a vertical position. The present invention thereby enables a user to transport a loaded bin for pickup without having to carry the loaded bin.

All of these features and advantages of the present invention, and more, are illustrated below in the drawings and detailed description that follow.

### BRIEF DESCRIPTION OF THE DRAWINGS

FIG. 1 shows a perspective view of a cart.

FIG. 2 shows a perspective view of a cart loaded with a recycling bin.

FIG. 3 shows a perspective view of a cart with a lowered ramp.

FIG. 4 shows a perspective view of a cart tilted to unload a recycling bin.

### DETAILED DESCRIPTION

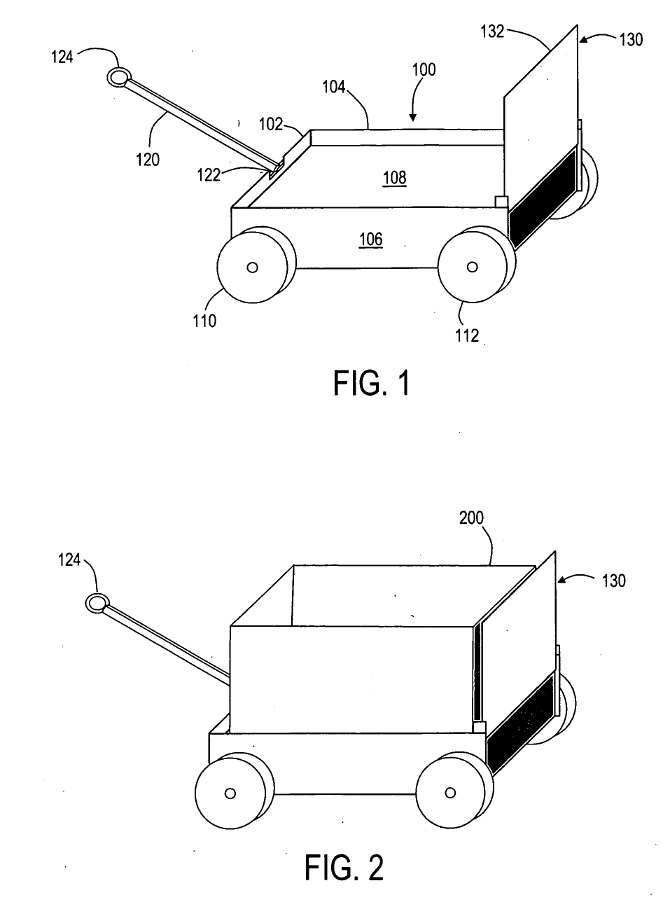

FIG. 1 shows a perspective view of a cart for transporting a recycling bin and other containers. In a preferred embodiment, the cart has a rectangular body 100 with a handle 124 and handle shaft 120, front wheels 110, rear wheels 112, and a ramp 130. The front side 102, right side 104, and left side 106 of the body 100 are raised about two inches above the supporting surface 108 to prevent containers placed on the supporting surface 108 from sliding off.

The handle shaft 120 is attached to the front side 102 by a hinge 122 as is known in the art. In a preferred embodiment, the combined length of the handle 124 and handle shaft 120 is about thirty-two inches. The handle shaft 120 may rest against the upper edge 132 of the ramp 130 when the cart is not in use. The ramp 130 is shown in an upright, locked position that prevents containers placed on the supporting surface 108 from sliding off.

The body 100 may be manufactured using well-known methods from corrosion-resistant plastics, metals, and other known materials of sufficient thickness to produce a box 100 capable of supporting at least 100 pounds on the supporting surface 108. Similarly, the handle 124, handle shaft 120, and ramp 130 may be manufactured using well-known methods from corrosion-resistant plastics, metals, and other known materials. The front 110 and rear 112 wheels are typically rubber-coated and 4 to 5 inches in diameter, with a front axle (not shown) joining the pair of front wheels 110 and a rear axle (not shown) joining the pair of rear wheels 112. The axles are corrosion-resistant metal rods as are well-known in the art and pass through suitably-positioned holes (not shown) in the body 100.

FIG. 2 shows a preferred embodiment of the cart with a storage container 200 resting on the supporting surface 108. Although the cart may be used to transport a variety of different containers, a preferred use is the transportation from the home to the curb of a plastic recycling bin utilized by many communities. A cart optimized for this purpose has a body 100 measuring approximately twenty-four inches in length, eighteen inches in width and two inches in depth, and a ramp measuring seventeen inches in width and twelve inches in length.

A person using the cart to transport a recycling bin typically locks the ramp in an upright position, places the bin 200 lengthwise as shown in FIG. 2, and parks the cart in the garage, yard, or another convenient location. The rearmost end of the bin 200 is preferably placed within one to two inches of the ramp 130. Recyclable materials are deposited in the bin 200 as is convenient. Just prior to a collection day the user grasps the handle 124 and draws the loaded cart out to a curbside collection location.

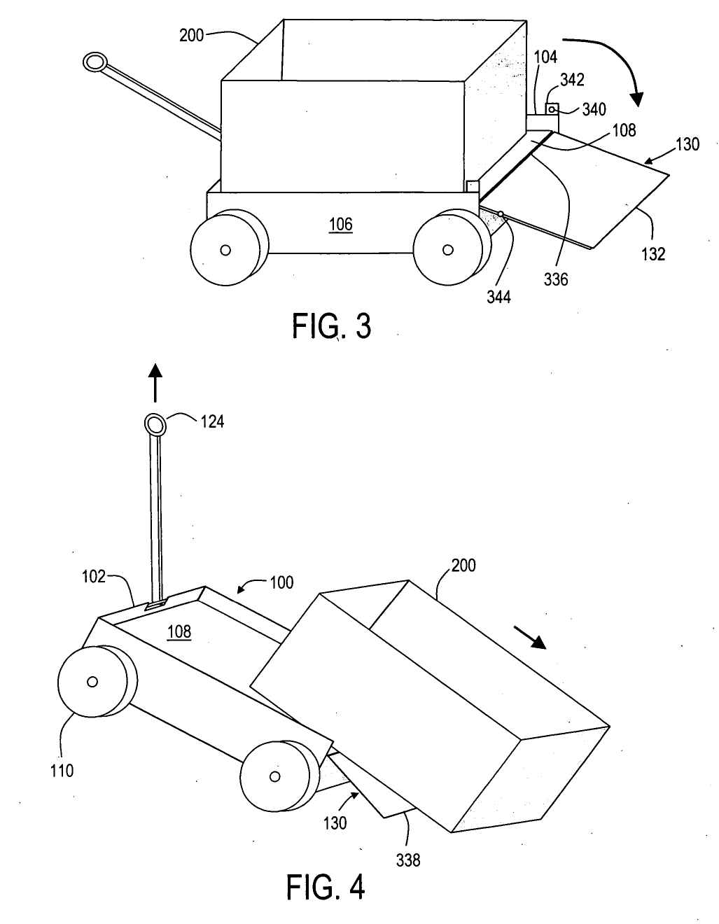

FIG. 3 shows a perspective view of a cart with a lowered ramp. Once at the collection location, the user unlocks the ramp 130 from the locked position shown in FIG. 2 by pushing the upper edge 132 of the ramp 130 rearward until the upper edge 132 of the ramp 130 rotates downward to rest upon the ground, usually at about a thirty degree angle.

The ramp 130 pivots about a hinge or set of hinges joining the ramp 130 to the body 100. In a preferred embodiment, a hinge may comprise pins that protrude from either lateral edge of the ramp 130 near the lower edge 336 and engage suitably sized and positioned holes in the right side 104 and left side 106. Alternatively, a piano hinge, flexible panel, or set of other hinges as are well-known in the art may directly connect the lower edge 336 of the ramp 130 to the supporting surface 108.

In a preferred embodiment the ramp 130 is locked in an upright position by nubs 344 on the lateral edges of the ramp 130. A nub 344 on each lateral edge engages a depression 340 in an ear 342 on each side 104, 106 of the body 100.

Once the ramp 130 is lowered the user may easily unload the bin 200. As shown in FIG. 4, when the upper edge 338 of the ramp 130 is resting upon the ground, the user lifts the handle 124 vertically, raises the front side 102 of the cart, and tilts the supporting surface 108 rearward until the bin 200 slides down the ramp 130 and contacts the ground. The user then lowers the cart until the front wheels 110 touch the ground, causing the bin 200 to slide off the ramp 130. The user may draw the cart forward a bit, allowing friction between the ground and the bin 200 to hold the bin 200 in place until the upper edge 338 of the ramp 130 slides entirely out from beneath the bin 200. The ramp 130 may then be returned to its locked, upright position. The user is thereby spared the necessity of lifting and carrying heavy bins full of recyclable materials.

The user usually draws the cart back to the parking location. When the contents of the bin have been collected, the user may draw the cart out again to collect the empty bin or simply carry the bin back to the parking location, replacing the bin 200 on the supporting surface 108 and the cart in the parking location.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

1. A cart for transporting containers, comprising:
a body, the body having a front side, a rear side, a left side, a right side, and a supporting surface; the front side, left side, and right side projecting vertically above the supporting surface;
a ramp, the ramp rotatably attached to the body, the ramp operable to lock in a vertical position parallel and proximate to rear side, the ramp projecting above the supporting surface while in the vertical position, the ramp further operable to rotate into an unlocked position wherein a portion of the ramp contacts the ground;
at least three wheels, the wheels rotatably attached to the body and operable to roll the body over the ground; and
a handle and a handle shaft, the handle disposed upon the distal end of the handle shaft, the proximal end of the handle shaft rotatably attached to the front side, the handle and handle shaft operable to draw the cart over the ground.

2. A cart for transporting containers as claimed in claim 1, comprising four wheels rotatably attached to the body and operable to roll the body over the ground.

3. A cart for transporting containers as claimed in claim 1, wherein the front side, left side, and right side project vertically at least two inches above the supporting surface.

4. A cart for transporting containers as claimed in claim 1, wherein body and wheels are capable of supporting at least 100 pounds.

5. A cart for transporting containers as claimed in claim 1, wherein the wheels are at least four inches in diameter.

6. A cart for transporting containers as claimed in claim 1, wherein the ramp is locked in an upright position by engagement between at least a first nub and at least a first depression.

7. A cart for transporting containers as claimed in claim 1, wherein the ramp at least initially rests at an angle of approximately thirty degrees when lowered to the ground.

8. A method for using a cart to transport and deposit containers, comprising:
positioning a container upon a supporting surface of a cart;
drawing the cart to a collection location;
lowering a ramp attached to a side of the cart until a portion of the ramp touches the ground;
sliding the container onto the ramp; and
drawing a side of the cart opposite the side to which the ramp is attached away from the ramp until the ramp slides entirely out from beneath the container.

9. A method for using a cart to transport and deposit containers, comprising:
locking in an upright position a ramp attached to the rear side of a cart;
positioning a container upon a supporting surface of the cart;
drawing the cart to a collection location;
lowering the ramp from a locked position to an unlocked position wherein a portion of the ramp touches the ground;
lifting the front side of the cart until the container slides down the ramp and touches the ground;
lowering the front side of the cart;
drawing the cart forward until the ramp slides entirely out from beneath the container; and
restoring the ramp to an upright, locked position.
